(19) United States
(12) Patent Application Publication
(10) Pub. No.: US 2025/0263822 A1
(43) Pub. Date: Aug. 21, 2025

(54) NEGATIVE ELECTRODE ACTIVE MATERIAL FOR NICKEL-METAL HYDRIDE BATTERY, AND METHOD FOR PRODUCING THE SAME

(71) Applicants: TOYOTA JIDOSHA KABUSHIKI KAISHA, Toyota-shi (JP); AICHI STEEL CORPORATION, Tokai-shi (JP); JAPAN METALS AND CHEMICALS CO., LTD., Tokyo (JP)

(72) Inventors: Makio KON, Toyota-shi (JP); Hiroyuki KAIYA, Toyota-shi (JP); Masanobu OUCHI, Nagoya-shi (JP); Tomoya MATSUNAGA, Susono-shi (JP); Hiroshi SUYAMA, Mishima-shi (JP); Shigeki SATO, Fujinomiya-shi (JP); Yusaku INATOMI, Susono-shi (JP); Takashi SAZUKA, Fuji-shi (JP); Ryoma SAKAI, Susono-shi (JP); Akihiro MATSUYAMA, Tokai-shi (JP); Takao SAWA, Nishiokitama-gun (JP); Katsuyuki KUDO, Nishiokitama-gun (JP); Tomoki SOUMA, Nishiokitama-gun (JP)

(73) Assignees: TOYOTA JIDOSHA KABUSHIKI KAISHA, Toyota-shi (JP); AICHI STEEL CORPORATION, Tokai-shi (JP); JAPAN METALS AND CHEMICALS CO., LTD., Tokyo (JP)

(21) Appl. No.: 19/044,363

(22) Filed: Feb. 3, 2025

(30) Foreign Application Priority Data
Feb. 15, 2024 (JP) 2024-021310

(51) Int. Cl. C22C 30/00; C22C 1/02; H01M 10/34

(52) U.S. Cl. CPC C22C 30/00; C22C 1/02; H01M 10/345

(57) ABSTRACT

The present disclosure provides a negative electrode active material for a nickel-metal hydride battery containing a hydrogen-absorbing alloy that contains Ti, Zr, Cr, Mn, and Ni, and further contains one or more elements selected from the group consisting of La and Ce, wherein a total content proportion of the one or more elements selected from the group consisting of La and Ce based on the entire hydrogen-absorbing alloy is 8 at % or less, and a method for producing the same.

### CROSS-REFERENCE TO RELATED APPLICATION

This application claims priority to Japanese Patent Application No. 2024-021310 filed on Feb. 15, 2024, incorporated herein by reference in its entirety.

### BACKGROUND

### 1. Technical Field

The present disclosure relates to a negative electrode active material for a nickel-metal hydride battery, and a method for producing the same.

### 2. Description of Related Art

A hydrogen-absorbing alloy is used as a negative electrode active material of a nickel-metal hydride battery. A hydrogen-absorbing alloy has been disclosed in, for example, Japanese Unexamined Patent Application Publication No. 10-36930. The hydrogen-absorbing alloy disclosed in JP 10-36930A contains prescribed amounts of Zr, Ti, Nb, V, Ni, Mn, Cr, Co, Fe, Si, Mo, and B, and further contains an intermetallic compound as an alloy phase, and the intermetallic compound has C15 or C14 type cubic crystal belonging to a Laves phase.

### SUMMARY

The present inventors have found the following problem: When the hydrogen-absorbing alloy disclosed in JP 10-36930A is used as a negative electrode active material, there arises a problem in initial activation, and for increasing a discharge capacity, the number of times of performing break-in charge/discharge is unavoidably increased.

The present disclosure has been devised for solving the problem, and an object is to provide a negative electrode active material for a nickel-metal hydride battery that is excellent in initial activation, and is capable of increasing a discharge capacity even when the number of times of performing break-in charge/discharge is small, and a method for producing the same.

An active material for a nickel-metal hydride battery, and a method for producing the same of the present disclosure can employ the following aspects:

<Aspect 1> A negative electrode active material for a nickel-metal hydride battery, containing a hydrogen-absorbing alloy that contains Ti, Zr, Cr, Mn, and Ni, and further contains one or more elements selected from the group consisting of La and Ce, wherein a total content proportion of the one or more elements selected from the group consisting of La and Ce based on the entire hydrogen-absorbing alloy is 8 at % or less.

<Aspect 2> The negative electrode active material for a nickel-metal hydride battery according to aspect 1, wherein:
the hydrogen-absorbing alloy contains a main phase, a grain boundary phase, and a third phase;
the main phase is an AB₂ type alloy phase, and the grain boundary phase is an AB type alloy phase;
in the AB₂ type alloy phase, A is one or more elements selected from the group consisting of Ti and Zr, and B is one or more elements selected from the group consisting of Cr, Mn, and Ni;
in the AB type alloy phase, A is one or more elements selected from the group consisting of Ti and Zr, and B is Ni; and
the third phase is an alloy phase containing one or more elements selected from the group consisting of La and Ce, and Ni.

<Aspect 3> The negative electrode active material for a nickel-metal hydride battery according to aspect 1 or 2, wherein a content proportion of Ni in the main phase is 14 at % or more and 21 at % or less based on the entire main phase.

<Aspect 4> A method for producing a negative electrode active material for a nickel-metal hydride battery including:
melting a raw material containing Ti, Zr, Cr, Mn, and Ni, and further containing one or more elements selected from the group consisting of La and Ce to obtain a molten metal; and
cooling the molten metal to solidify the molten metal and thereby obtain an ingot of a hydrogen-absorbing alloy, wherein a total content proportion of the one or more elements selected from the group consisting of La and Ce is 8 at % or less based on the entire molten metal.

<Aspect 5> The method for producing a negative electrode active material for a nickel-metal hydride battery according to aspect 4, further including exposing the ingot to an alkaline solution.

According to the present disclosure, a negative electrode active material for a nickel-metal hydride battery that is excellent in initial activation, and is capable of increasing a discharge capacity even when the number of times of performing break-in charge/discharge is small, and a method for producing the same can be provided by further adding a small amount of one or more elements selected from the group consisting of La and Ce to a hydrogen-absorbing alloy containing Ti, Zr, Cr, Mn, and Ni.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph illustrating the relationship between the number of times of performing a break-in operation and a discharge capacity;

FIG. 2 is an explanatory diagram illustrating a result of an EDX surface analysis obtained in a sample of Example 1; and

FIG. 3 is an explanatory diagram illustrating a result of an EDX surface analysis obtained in a sample of Comparative Example 1.

### DETAILED DESCRIPTION OF EMBODIMENTS

It is noted that embodiments described below do not limit a negative electrode active material for a nickel-metal hydride battery of the present disclosure (hereinafter, also referred to simply as the “negative electrode active material of the present disclosure”) and a method for producing the same.

Without intending to be bound to any theory, the findings obtained by the present inventors on the reason why the negative electrode active material of the present disclosure is excellent in initial activation, and is capable of increasing a discharge capacity even when the number of times of performing break-in charge/discharge is small will be described.

A hydrogen-absorbing alloy containing Ti, Zr, Cr, Mn, and Ni is a two-phase alloy including an AB₂ type alloy phase mainly responsible for hydrogen-absorbing, and an AB type alloy phase mainly responsible for charge/discharge activity. Both the AB₂ type alloy phase and the AB type alloy phase contain Ni. Ni contained in the AB type alloy phase contributes to the charge/discharge activity, but Ni contained in the AB₂ type alloy phase minimally contributes to the charge/discharge activity.

When a small amount of one or more elements selected from the group consisting of La and Ce is added to the two-phase alloy, the added element and an element containing Ni together form an alloy phase, and the alloy phase constitutes a third phase coexisting with the AB₂ type alloy phase and the AB type alloy phase. Since the third phase is thus formed, the content proportion of Ni in the AB₂ type alloy phase is reduced, and the third phase contributes to the charge/discharge activity together with the AB type alloy phase. The present inventors have found that, in this manner, excellent initial activation is obtained, and the discharge capacity can be increased even when the number of times of performing break-in charge/discharge is small.

Components of the negative electrode active material of the present disclosure and the method for producing the same based on the findings will now be described.

### Negative Electrode Active Material

The negative electrode active material of the present disclosure contains a hydrogen-absorbing alloy that contains Ti (titanium), Zr (zirconium), Cr (chromium), Mn (manganese), and Ni (nickel), and further contains one or more elements selected from the group consisting of La (lanthanum) and Ce (cerium). The content proportion of each of the elements are not especially limited as long as a hydrogen-absorbing alloy is obtained, and are preferably as follows. That the sum of the upper limits of the content proportions of the respective elements is over 100 at % means that all the content proportions of the respective elements are not the upper limits.

### Ti and Zr

The content proportion of each of Ti and Zr is preferably 10 at % or more, 12 at % or more, 14 at % or more, or 16 at % or more, and preferably 50 at % or less, 40 at % or less, 30 at % or less, 25 at % or less, 24 at % or less, 23 at % or less, 22 at % or less, 21 at % or less, 20 at % or less, or 19 at % or less based on the entire hydrogen-absorbing alloy.

### Cr

The content proportion of Cr is preferably 10 at % or more, 12 at % or more, 14 at % or more, 16 at % or more, 18 at % or more, 20 at % or more, 22 at % or more, 24 at % or more, or 26 at % or more, and is preferably 50 at % or less, 40 at % or less, 35 at % or less, 30 at % or less, 29 at % or less, or 28 at % or less based on the entire hydrogen-absorbing alloy.

### Mn

The content proportion of Mn is preferably 2 at % or more, 4 at % or more, 6 at % or more, or 8 at % or more, and is preferably 50 at % or less, 40 at % or less, 30 at % or less, 25 at % or less, 20 at % or less, 18 at % or less, 16 at % or less, 14 at % or less, 12 at % or less, or 10 at % or less based on the entire hydrogen-absorbing alloy. For improving the corrosion resistance of the hydrogen-absorbing alloy, the content proportion of Mn is particularly preferably 14 at % or less, 12 at % or less, or 10 at % or less based on the entire hydrogen-absorbing alloy. Even when the content proportion of Mn is thus reduced, the hydrogen-absorbing alloy used in the negative electrode active material of the present disclosure can be comparatively easily subjected to an alkaline dissolution treatment, and makes a contribution to the improvement of the charge/discharge activity. This is because the third phase is present in the hydrogen-absorbing alloy.

### Ni

The content proportion of Ni is preferably 15 at % or more, 20 at % or more, 22 at % or more, 24 at % or more, or 25 at % or more, and is preferably 60 at % or less, 55 at % or less, 50 at % or less, 45 at % or less, 40 at % or less, 38 at % or less, 36 at % or less, 34 at % or less, 32 at % or less, or 30 at % or less based on the entire hydrogen-absorbing alloy.

### La and Ce

The one or more elements selected from the group consisting of La and Ce may be contained in a small amount. The total content proportion of the one or more elements selected from the group consisting of La and Ce is 8 at % or less, 7 at % or less, 6 at % or less, 5 at % or less, 4 at % or less, 3 at % or less, 2 at % or less, or 1 at % or less based on the entire hydrogen-absorbing alloy. When the total content proportion of the one or more elements selected from the group consisting of La and Ce is over 8 at %, the battery capacity 30 is reduced.

When an alkaline dissolution treatment is performed, some of the one or more elements selected from the group consisting of La and Ce are desorbed from the hydrogen-absorbing alloy through the alkaline dissolution treatment. It is, however, substantially difficult for the whole of the one or more elements selected from the group consisting of La and Ce to desorb from the hydrogen-absorbing alloy through the alkaline dissolution treatment. Therefore, the total content proportion of the one or more elements selected from the group consisting of La and Ce may be 0.1 at % or more, 0.2 at % or more, 0.3 at % or more, 0.4 at % or more, 0.5 at % or more, 0.6 at % or more, 0.7 at % or more, 0.8 at % or more, or 0.9 at % or less.

When only either La or Ce is contained among the group consisting of La and Ce, the content proportion of the either may be the total content proportion described above. It is noted that B (boron) may be added to the group consisting of La and Ce, and in the description given above, “one or more elements selected from the group consisting of La and Ce” may be read as “one or more elements selected from the group consisting of La, Ce, and B”. When only one of La, Ce, or B is contained among the group consisting of La, Ce, and B, the content proportion of any one of them may be the total content proportion described above.

### Other Elements

Some of Ti, Zr, Cr, Mn, and Ni contained in the hydrogen-absorbing alloy may be substituted with one or more elements selected from the group consisting of Fe (iron), Co (cobalt), V (vanadium), Nb (niobium), Mo (molybdenum), B (boron), Mg (magnesium), and Al (aluminum). A total content proportion of the substituted elements such as Fe is preferably 50 at % or less, 40 at % or less, 30 at % or less, 20 at % or less, 10 at % or less, 5 at % or less, or 0 at % based on the entire hydrogen-absorbing alloy. This does not practically harmfully affect the negative electrode active material and the method for producing the same of the present disclosure. The sum of the content proportions of 0 at % means that the elements are not substituted. Besides, when only one element is used as the substituted elements such as Fe, the content proportion of the element may be the total content proportion described above.

In other words, the hydrogen-absorbing alloy contains Ti, Zr, Cr, Mn, and Ni, and essentially further contains one or more elements selected from the group consisting of La and Ce, in which some of Ti, Zr, Cr, Mn, and Ni are optionally substituted with one or more elements selected from the group consisting of Fe, Co, V, Nb, Mo, B, Mg, and Al, and the balance may be inevitable impurities. Herein, the term “inevitable impurities” means, unless otherwise stated, a substance that cannot be avoided from being contained, or considerably increases the production cost for avoiding the containing, such as an impurity contained in a raw material, or an impurity unavoidably mixed in a production process.

The negative electrode active material of the present disclosure can contain a substance other than the hydrogen-absorbing alloy and inevitable impurities as long as the function is not impaired. An example of the substance other than the hydrogen-absorbing alloy includes a corrosion inhibitor. The total content proportion of the substance other than the hydrogen-absorbing alloy and the inevitable impurities may be 5% by mass or less, 3% by mass or less, or 1% by mass or less based on the entire negative electrode active material. In consideration of the inevitable impurities, the total content proportion of the substance other than the hydrogen-absorbing alloy and the inevitable impurities may be 0.1% by mass or more, 0.3% by mass or more, or 0.5% by mass or more.

### Structure

The hydrogen-absorbing alloy used in the negative electrode active material of the present disclosure has an AB₂ type alloy phase as the main phase, an AB type alloy phase as the grain boundary phase, and the third phase. It is noted that both the “AB₂ type alloy phase” and the “AB type alloy phase” conform to the conventional notation for alloy phases in hydrogen-absorbing alloys, but if it is apprehended that confusion with element B (boron) may be caused, the “AB₂ type alloy phase” and the “AB type alloy phase” may be written respectively as, for example, the “ab₂ type alloy phase” and the “ab type alloy phase”. The main phase, the grain boundary phase, and the third phase will now be respectively described.

### Main Phase

The main phase is the AB₂ type alloy phase. The term “AB₂ type alloy phase” means an alloy phase of 1 mol of the element “A” and 2 moles of the element “B”. A is one or more elements selected from the group consisting of Ti (titanium) and Zr (zirconium), and B is one or more elements selected from the group consisting of Cr (chromium), Mn (manganese), and Ni (nickel). The AB₂ type alloy phase containing the elements typically has a Laves structure. An AB₂ type alloy phase having such a structure mainly has a hydrogen-absorbing function.

The main phase may typically contain, as the element “B”, 14 at % or more and 21 at % or less of Ni based on the entire main phase. In a conventional hydrogen-absorbing alloy not containing a third phase, the main phase typically contains 21.3 at % or more of Ni based on the entire main phase. The main phase is the AB₂ type alloy phase having a Laves structure as described above, and Ni present in such a structure minimally exhibits charge/discharge activity.

In the hydrogen-absorbing alloy used in the negative electrode active material of the present disclosure, the main phase, the grain boundary phase, and the third phase coexist, and therefore, the content proportion of Ni in the main phase can be reduced to 14 at % or more and 21 at % or less based on the entire main phase. From this point of view, the main phase may contain 14 at % or more, 15 at % or more, or 16 at % or more, and 21 at % or less, 20 at % or less, 19 at % or less, 18 at % or less, or 17 at % or less of Ni based on the entire main phase.

Since the main phase is present in the hydrogen-absorbing alloy as the main phase, the volume proportion of the main phase may be, for example, 50% or more, 60% or more, 70% or more, or 75% or more, and may be 95% or less, 90% or less, 85% or less, or 80% or less based on the entire hydrogen-absorbing alloy.

Some of constituent elements of the AB₂ type alloy phase may be substituted with one or more elements selected from the group consisting of Fe, Co, V, Nb, Mo, B, Mg, and Al. This also applies to the AB type alloy phase and the third phase described below.

### Grain Boundary Phase

The grain boundary phase is the AB type alloy phase. The term “AB type alloy phase” means an alloy phase of 1 mol of the element “A” and 1 mol of the element “B”. A is one or more elements selected from the group consisting of Ti (titanium) and Zr (zirconium), and B is Ni (nickel). An AB type alloy phase containing the elements typically has a CsCl type crystal structure. An AB type alloy phase having such a crystal structure has charge/discharge activation function.

The grain boundary phase is present between mutually adjacent main phases among a plurality of main phases. Also the third phase described below is present between mutually adjacent main phases among a plurality of main phases. In the hydrogen-absorbing alloy, the grain boundary phase and the third phase correspond to a balance of the main phase. Therefore, the total volume proportion of the grain boundary phase and the third phase may be, for example, 5% or more, 10% or more, 15% or more, or 20% or more, and 50% or less, 40% or less, 30% or less, or 25% or less based on the entire hydrogen-absorbing alloy.

In the hydrogen-absorbing alloy, another phase may be present in addition to the main phase, the grain boundary phase, and the third phase. The another phase present in addition to the main phase, the grain boundary phase, and the third phase is typically a phase containing inevitable impurities, and the volume proportion may be 5% or less, 4% or less, 3% or less, 2% or less, 1% or less, or 0% based on the entire hydrogen-absorbing alloy. A volume proportion of 0% means that no phase other than the main phase, the grain boundary phase, and the third phase is present. If it is practically difficult that no phase other than the main phase, the grain boundary phase, and the third phase is present, the volume proportion of the phase other than the main phase, the grain boundary phase, and the third phase may be 0.1% or more, 0.3% or more, 0.5% or more, 0.7% or more, or 0.9% or more.

### Third Phase

The third phase is an alloy phase containing one or more elements selected from the group consisting of La and Ce, and Ni. The form of the alloy phase is typically an intermetallic compound, but is not limited thereto, and a part or the whole of the alloy phase may form a solid solution with another part.

When an alkaline solution treatment is not performed, the content proportion of Ni may be 20 at % or more, 30 at % or more, or 40 at % or more, and may be 70 at % or less, 60 at % or less, or 50 at % or less based on the entire third phase. When the alkaline solution treatment is not performed, a total content proportion of the one or more elements selected from the group consisting of La and Ce may be 20 at % or more, 30 at % or more, or 40 at % or more, and may be 70 at % or less, 60 at % or less, or 50 at % or less based on the entire third phase. When the alkaline solution treatment is not performed, the total content proportion of each of Ti and Zr may be optionally 1 at % or more, 2 at % or more, or 3 at % or more, and may be 6 at % or less, 5 at % or less, or 4 at % or less. The balance is inevitable impurities. The inevitable impurities include Cr and Mn.

When the alkaline solution treatment is performed, most of elements contained in the third phase excluding Ni are desorbed by the alkaline solution treatment, resulting in forming a Ni concentrated phase using the one or more elements selected from the group consisting of La and Ce as the nucleus. When the alkaline solution treatment is performed, the total content proportion of the one or more elements selected from the group consisting of La and Ce in the third phase may be 0.1 at % or more, 0.3 at % or more, 0.5 at % or more, 0.7 at % or more, or 0.9 at % or more, and may be 3 at % or less, 2 at % or less, or 1 at % or less based on the entire third phase. The balance is Ni and inevitable impurities.

The composition of the third phase is largely varied depending on whether or not the alkaline solution treatment is performed. The composition of the main phase is, however, minimally changed depending on whether or not the alkaline solution treatment is performed, and hence, the hydrogen-absorbing alloy used in the negative electrode active material of the present disclosure can be specified by the content proportion of Ni in the main phase described above.

The total volume proportion of the grain boundary phase and the third phase has been described above, and the volume proportion of the third phase to the total volume proportion of the grain boundary phase and the third phase may be 5% or more, 10% or more, 15% or more, 20% or more, 25% or more, or 30% or more, and may be 50% or less, 45% or less, or 40% or less. When the volume proportion of the third phase to the total volume proportion of the grain boundary phase and the third phase is 5% or more, it can be practically recognized that excellent initial activation is obtained, and the discharge capacity is increased even when the number of times of performing break-in charge/discharge is small. When the volume proportion of the third phase to the total volume proportion of the grain boundary phase and the third phase is 50% or less, the coexistence of the main phase, the grain boundary phase, and the third phase can be advantageously realized.

### Structure Specifying Method

A hydrogen-absorbing alloy is cut and polished, and a SEM image (backscattered electron image) of the polished surface is obtained. The SEM image is subjected to EDX surface analysis. When the hydrogen-absorbing alloy is in the form of a powder resulting from crushing or the like, the powder may be embedded in a resin, and the resultant may be polished to obtain a SEM image.

Since the respective regions of the main phase, the grain boundary phase, and the third phase have different component compositions, the respective regions of the main phase, the grain boundary phase, and the third phase can be distinguishingly identified in the result of the EDX surface analysis. Then, the area ratios of the respective regions are measured with an image processor, and thus, the volume proportions of each of the main phase, the grain boundary phase, and the third phase are determined.

### Method for Producing Negative Electrode Active Material

A method for producing a negative electrode active material of the present disclosure (hereinafter, also referred to simply as the “production method of the present disclosure”) includes molten metal preparation, and molten metal cooling, and optionally includes alkaline dissolution treatment.

### Molten Metal Preparation

A raw material containing Ti, Zr, Cr, Mn, and Ni, and further containing one or more elements selected from the group consisting of La and Ce is melted to obtain a molten metal.

The component composition range of the molten metal is basically the same as the component composition range of the hydrogen-absorbing alloy described in “Negative Electrode Active Material”. If, however, the component composition is varied due to decrease or the like of a specific element or the like during the production process, the variation of the component composition may be precedently considered in melting the raw material such that the component composition range of the molten metal accords with the component composition range of the hydrogen-absorbing alloy. In the description given in “Method for Producing Negative Electrode Active Material”, the term “entire hydrogen-absorbing alloy” is read as “entire molten metal”.

The melting method is not especially limited, and for example, a method in which the raw material put in a crucible is arc melted to obtain the molten metal can be employed. For preventing oxidation of the raw material and the molten metal, it is preferred that the raw material is melted in an inert gas atmosphere, particularly in an argon gas atmosphere. As the inert gas atmosphere, elements of group XVIII such as argon are recommended.

### Molten Metal Cooling

The molten metal is solidified by cooling the molten metal to obtain an ingot of a hydrogen-absorbing alloy. The molten metal cooling method is not especially limited, and for example, a method in which the raw material put in a crucible is arc melted, and then the resultant molten metal is directly cooled in the crucible can be employed. The cooling rate in such a method is about 0.1° C./sec or more, and less than 100° C./sec.

For preventing oxidation of the raw material and the molten metal, it is preferred that the molten metal is cooled in an inert gas atmosphere, particularly in an argon gas atmosphere. The inert gas atmosphere encompasses a nitrogen gas atmosphere. Besides, for obtaining a homogenous component composition within the ingot, the melting and the molten metal cooling may be performed repeatedly a plurality of times.

### Alkaline Dissolution Treatment

The elements excluding Ni present in the third phase may be desorbed from the third phase by exposing the ingot to an alkaline solution to obtain a Ni concentrated phase. Thus, the initial activation is further increased, and the discharge capacity can be further increased even when the number of times of performing break-in charge/discharge is small.

The type of the alkaline solution is not especially limited, and a NaOH (sodium hydroxide) aqueous solution is typically used. The concentration of the alkaline solution may be appropriately determined. In using a NaOH aqueous solution, the concentration may be, for example, 10% by mass or more, 20% by mass or more, or 30% by mass or more, and may be 50% by mass or less, 45% by mass or less, or 40% by mass or less.

The treatment temperature and the treatment time may be appropriately determined in accordance with the type and the concentration of the alkaline solution, and the amount to be treated, and the like. The treatment temperature may be, for example, 70° C. or more, 80° C. or more, or 90° C. or more, and may be 130° C. or less, 120° C. or less, or 110° C. or less. The treatment time may be, for example, 1 hour or more, 2 hours or more, or 3 hours or more, and may be 7 hours or less, 6 hours or less, or 5 hours or less.

### Preparation of Sample

A raw material having a component composition shown in Table 1 was put in a crucible, and arc melted to obtain a molten metal, and the resultant molten metal was solidified by cooling it in the crucible to obtain an ingot. The melting and cooling were repeated 3 times in the crucible to homogenize the component composition of the ingot. The raw material of Zr had a purity of 98% by mass, and the raw materials of the other elements had a purity of 99.9% by mass.

TABLE 1
unit: at %

| | Ti | Zr | Cr | Mn | Ni | La | Ce | B |
|---|---|---|---|---|---|---|---|---|
| Com. Ex. 1 | 17.78 | 17.78 | 26.67 | 8.89 | 28.89 | — | — | — |
| Ex. 1 | 17.02 | 17.02 | 25.53 | 8.51 | 27.66 | — | 4.26 | — |
| Ex. 2 | 17.02 | 17.02 | 25.53 | 8.51 | 27.66 | 4.26 | — | — |
| Ex. 3 | 17.47 | 17.47 | 26.20 | 8.73 | 28.38 | — | 1.75 | — |
| Ex. 4 | 17.62 | 17.62 | 26.43 | 8.81 | 28.63 | — | 0.88 | — |
| Com. Ex. 2 | 16.33 | 16.33 | 24.49 | 8.16 | 26.53 | — | 8.16 | — |
| Ref. Ex. 1 | 17.02 | 17.02 | 25.53 | 8.51 | 27.66 | — | — | 4.26 |

The ingot was crushed with a manual stamp mill DA-30 manufactured by Tokyo Garasu Kikai Co., Ltd., and the thus obtained powder was classified to 38 to 100 μm with 38 μm and 100 μm sieves.

The classified powder was put into a NaOH aqueous solution for performing alkaline dissolution treatment. The concentration of the NaOH aqueous solution was 35% by mass. The amount of the NaOH aqueous solution was 80 ml. The amount of the powder was 2.0 g. The treatment temperature was 100° C. The treatment time was 4 hours.

The powder resulting from the alkaline dissolution treatment was washed with water, filtered, and then vacuum dried.

### Evaluation

Each sample was evaluated as follows. Each evaluation was performed after the alkaline dissolution treatment unless otherwise stated.

### Component Composition

Each sample was subjected to quantitative analysis by ICP before the alkaline dissolution treatment. The results are shown in Table 2. It can be thus confirmed that variation in the component composition between the component composition of the raw material and the component composition of the sample causes no practical problem in all samples.

TABLE 2
unit: at %

| | Ti | Zr | Cr | Mn | Ni | La | Ce | B |
|---|---|---|---|---|---|---|---|---|
| Com. Ex. 1 | 18.18 | 17.75 | 26.85 | 8.56 | 28.66 | — | — | — |
| Ex. 1 | 17.22 | 16.94 | 25.95 | 6.65 | 28.24 | — | 5.00 | — |
| Ex. 2 | 16.45 | 15.81 | 23.09 | 7.48 | 30.15 | 7.02 | | — |
| Ex. 3 | 18.31 | 17.66 | 27.84 | 6.06 | 28.45 | — | 1.68 | — |
| Ex. 4 | 18.11 | 17.70 | 26.60 | 6.95 | 29.66 | — | 0.97 | — |
| Com. Ex. 2 | 15.61 | 15.11 | 21.99 | 6.45 | 31.39 | — | 9.44 | — |
| Ref. Ex. 1 | 17.41 | 17.26 | 25.57 | 7.92 | 28.27 | — | — | 3.58 |

### Discharge Characteristics

A cell for evaluation was produced as follows.

First, a negative electrode was produced. More specifically, a paste composition was prepared by kneading 49 parts by mass of the hydrogen-absorbing alloy used as a negative electrode active material, 49 parts by mass of a Ni powder used as a conductive auxiliary agent, and 2 parts by mass of carboxymethyl cellulose (CMC) used as a binder. The paste composition was put on a negative electrode current collector, and subsequently, the resultant was vacuum dried at 80° C., and then subjected to roll press (clearance: 300 μm) by pressing at about 8 kN to obtain a negative electrode. As the negative electrode current collector, a porous nickel (Celmet #7, manufactured by Sumitomo Electric Industries, Ltd., thickness: 1.6 mm) on which a Ni tab had been welded was used. The capacity was adjusted by targeting about 240 mAh.

Next, a positive electrode was produced. More specifically, a paste composition was prepared by kneading 88 parts by mass of nickel hydroxide (Ni(OH)₂) used as a positive electrode active material, 10 parts by mass of cobalt oxide (CoO) used as a conductive auxiliary agent, and 1 part by mass each of two binders (carboxymethyl cellulose (CMC) and polyvinyl alcohol (PVA)). The paste composition was put on the porous nickel, and subsequently vacuum dried at 80° C., and the resultant was subjected to roll press by pressing at about 8 kN to obtain a positive electrode. The capacity ratio between the negative electrode and the positive electrode was adjusted to negative electrode: positive electrode of 1:4.5.

Next, an electrolytic solution was produced. Pure water was added to KOH to adjust the concentration of KOH to 6 mol/L, and thus, 90 ml of an electrolytic solution was obtained. Thereafter, the electrolytic solution and a separator (PE/PP nonwoven fabric, thickness: 150 μm) were disposed in a container, and then, the negative electrode (working electrode), the positive electrode (counter electrode), and a Hg/HgO electrode (reference electrode) were disposed therein to obtain a cell for evaluation.

The cell for evaluation thus obtained was used to perform charge/discharge test (25° C.). First, break-in charge/discharge was performed until the negative electrode capacity was saturated. More specifically, charge/discharge through the following procedures (1) to (4) was performed.

(1) The cell was charged at 0.1 C for 14 hours, and then discharged at 0.1 C until the negative electrode potential reached-0.6 V.

(2) The cell was charged at 0.5 C for 2.2 hours, and then discharged at 0.5 C until the negative electrode potential reached-0.6 V.

(3) The cell was subsequently charged at 0.1 C for 14 hours, and then discharged at 0.1 C until the negative electrode potential reached-0.6 V.

(4) The charge/discharge procedures (1) to (3) were repeatedly performed until the capacity at 0.1 C discharge was saturated, and the thus obtained electrode capacity was determined as an initial capacity.

The break-in charge/discharge was performed once to 4 times (once to 5 times in Comparative Example 1), and each cell for evaluation after the break-in charge/discharge was charged at 0.2 C for 7.5 hours, subsequently discharged at 0.1 C until the negative electrode potential reached-0.5 V, and the capacity was checked.

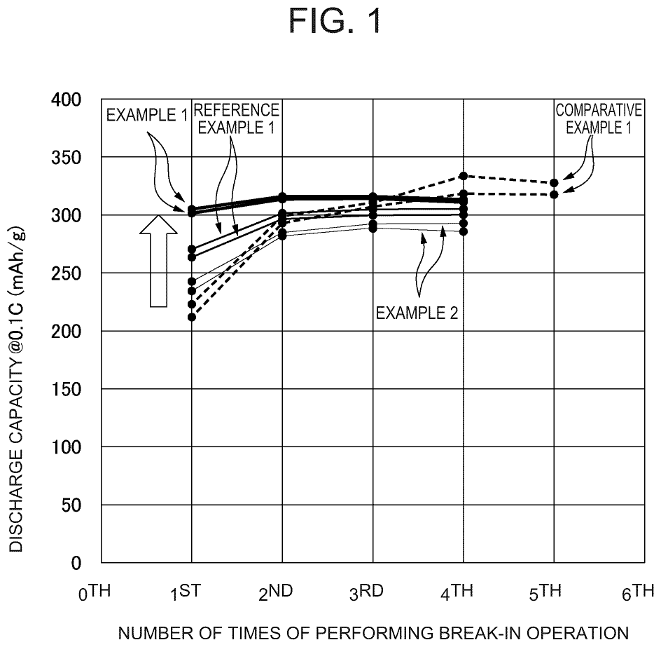

The results are shown in FIG. 1 and Table 3. In FIG. 1, two results are illustrated with respect to each sample because the test was performed twice under the same conditions. Besides, the results shown in Table 3 are averages of results of the test performed a plurality of times.

TABLE 3
unit: mAh/g

| | 1st | 2nd | 3rd | 4th | 5th |
|---|---|---|---|---|---|
| Com. Ex. 1 | 211.6 | 292.0 | 305.5 | 317.6 | 317 |
| Ex. 1 | 303.5 | 314.9 | 315.0 | 313.2 | — |
| Ex. 2 | 234.9 | 284.0 | 291.9 | 292.5 | — |
| Ex. 3 | 326.2 | 342.6 | 343.8 | 342.2 | — |
| Ex. 4 | 238.4 | 313.1 | 323.7 | 328.2 | — |
| Com. Ex. 2 | 263.9 | 268.3 | 264.4 | 257.5 | — |
| Ref. Ex. 1 | 269.9 | 299.9 | 304.4 | 304.4 | — |

It can be understood, based on FIG. 1 and Table 3, that the samples of Examples 1 and 2 have higher discharge capacities than the sample of Comparative Example 1 (a sample not containing one or more elements selected from the group consisting of La and Ce) even when the break-in charge/discharge is performed once. Besides, it can be confirmed that the sample of Comparative Example 2 has a higher discharge capacity than the sample of Comparative Example 1 even when the break-in charge/discharge is performed once, but the battery capacity was lower because the content proportion of Ce was excessively high.

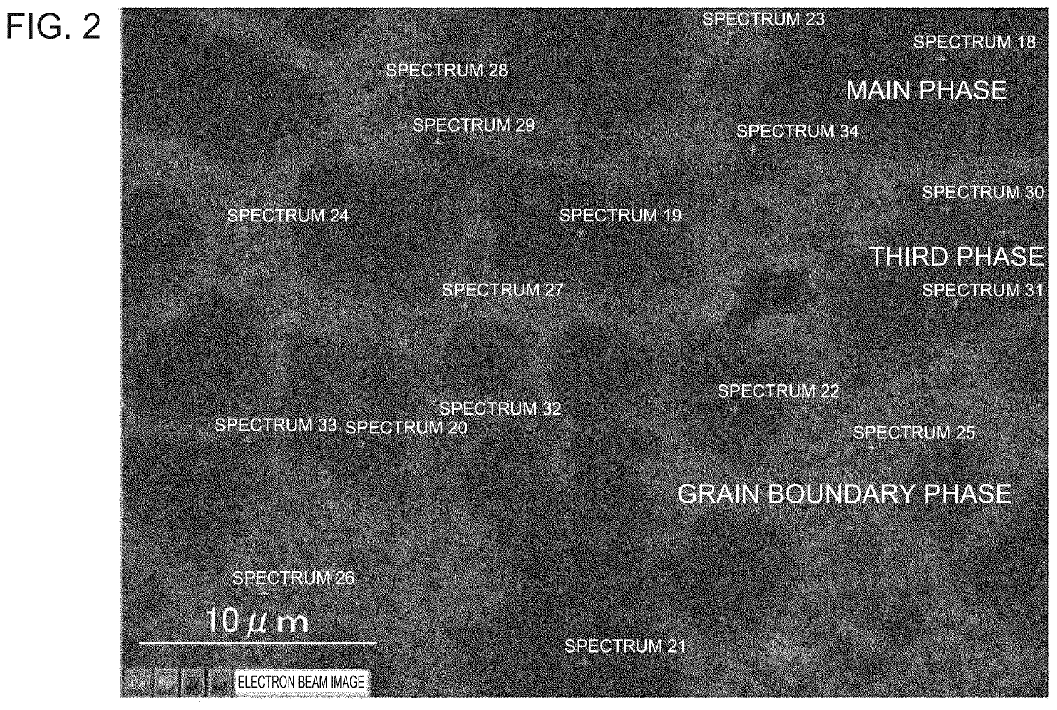

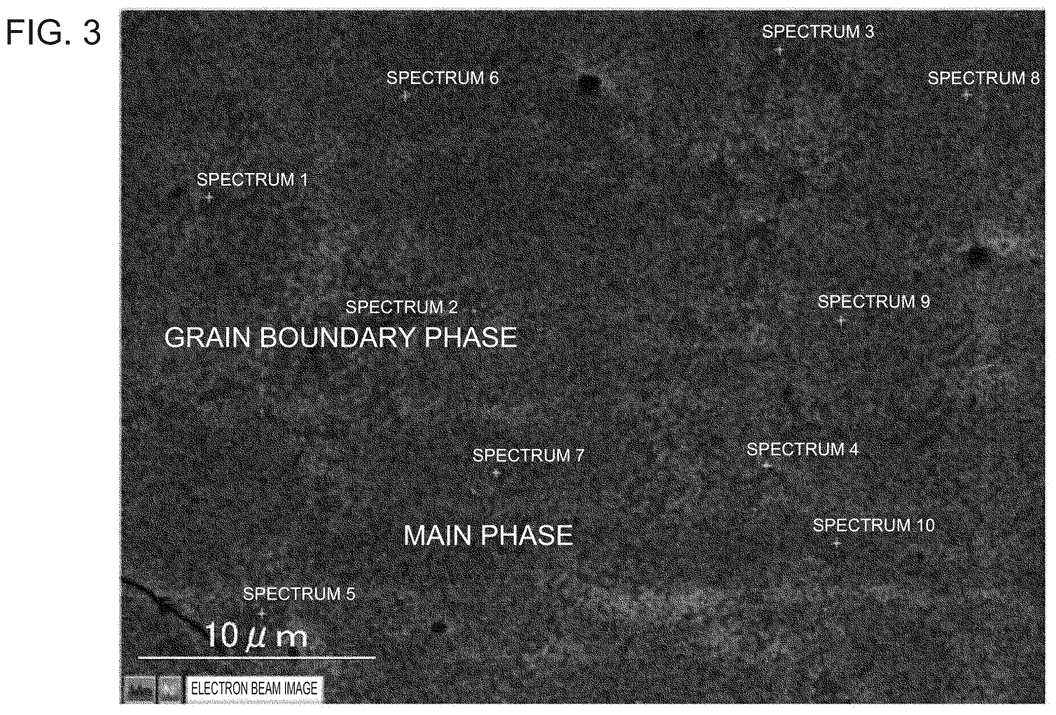

The samples of Example 1 and Comparative Example 1 were subjected to EDX surface analysis before the alkaline dissolution treatment. FIG. 2 is an explanatory diagram illustrating the result of the EDX surface analysis obtained in the sample of Example 1. FIG. 3 is an explanatory diagram illustrating the result of the EDX surface analysis obtained in the sample of Comparative Example 1.

It can be understood, based on FIGS. 2 and 3, that not only the main phase and the grain boundary phase but also the third phase were present in the sample of Example 1 but the third phase was not present in the sample of Comparative Example 1.

As a result of component analysis of the sample of Example 1 performed at 5 points in the main phase region, content average of Ti was 16.20 at %, of Zr was 17.40 at %, of Cr was 43.98 at %, of Mn was 6.75 at %, of Ni was 15.68 at %, and of Ce was below the detection limit.

As a result of component analysis of the sample of Example 1 performed at 5 points in the grain boundary phase region, content average of Ti was 28.38 at %, of Zr was 18.24 at %, of Cr was 1.95 at %, of Mn was 2.34 at %, of Ni was 49.09 at %, and of Ce was below the detection limit. It appears that Cr and Mn are affected by the main phase present below the grain boundary phase (on the back side in the paper).

As a result of component analysis of the sample of Example 1 performed at 5 points in the third phase region, content average of Ti was 2.76 at %, of Zr was 3.46 at %, of Cr was below the detection limit, of Mn was below the detection limit, of Ni was 46.12 at %, and of Ce was 48.91 at %. It also appears that Cr and Mn may be affected by the main phase present below the grain boundary phase (on the back side in the paper).

As a result of component analysis of the sample of Comparative Example 1 performed at 5 points in the main phase region, content average of Ti was 15.99 at %, of Zr was 17.93 at %, of Cr was 35.84 at %, of Mn was 8.91 at %, and of Ni was 21.33 at %.

As a result of component analysis of the sample of Comparative Example 1 performed at 5 points in the grain boundary phase region, content average of Ti was 27.63 at %, of Zr was 18.03 at %, of Cr was 2.70 at %, of Mn was 3.39 at %, and of Ni was 48.26 at %.

It can be understood, based on the results of the point analysis (component analysis) described above, that the third phase having a high content proportion of Ni is present in the sample of Example 1. Besides, it can be understood that the content proportion of Ni in the main phase is reduced from 21.33 at % to 15.68 at % in the sample of Example 1 as compared with that in the sample of Comparative Example 1.

What is claimed is:

1. A negative electrode active material for a nickel-metal hydride battery, comprising a hydrogen-absorbing alloy that comprises Ti, Zr, Cr, Mn, and Ni, and further comprises one or more elements selected from the group consisting of La and Ce, wherein a total content proportion of the one or more elements selected from the group consisting of La and Ce based on the entire hydrogen-absorbing alloy is 8 at % or less.

2. The negative electrode active material for a nickel-metal hydride battery according to claim 1, wherein:
the hydrogen-absorbing alloy contains a main phase, a grain boundary phase, and a third phase;
the main phase is an AB₂ type alloy phase, and the grain phase is an AB type alloy phase;
in the AB₂ type alloy phase, A is one or more elements selected from the group consisting of Ti and Zr, and B is one or more elements selected from the group consisting of Cr, Mn, and Ni;
in the AB type alloy phase, A is one or more elements selected from the group consisting of Ti and Zr, and B is Ni; and
the third phase is an alloy phase containing one or more elements selected from the group consisting of La and Ce, and Ni.

3. The negative electrode active material for a nickel-metal hydride battery according to claim 1, wherein a content proportion of Ni in the main phase is 14 at % or more and 21 at % or less based on the entire main phase.

4. A method for producing a negative electrode active material for a nickel-metal hydride battery, the method comprising:
melting a raw material comprising Ti, Zr, Cr, Mn, and Ni, and further comprising one or more elements selected from the group consisting of La and Ce to obtain a molten metal; and
cooling the molten metal to solidify the molten metal and thereby obtain an ingot of a hydrogen-absorbing alloy, wherein a total content of the one or more elements selected from the group consisting of La and Ce based on the entire molten metal is 8 at % or less.

5. The method for producing a negative electrode active material for a nickel-metal hydride battery according to claim 4, further comprising exposing the ingot to an alkaline solution.
